(19) United States
(12) Patent Application Publication
(10) Pub. No.: US 2018/0093870 A1
(43) Pub. Date: Apr. 5, 2018

(54) Winch Fairlead Pivot

(71) Applicants: David R. Hall, Provo, UT (US); Daniel Madsen, Vineyard, UT (US); Benjamin Taylor, Provo, UT (US); Joe Fox, Spanish Fork, UT (US); Lloyd J. Wilson, Herriman, UT (US)

(72) Inventors: David R. Hall, Provo, UT (US); Daniel Madsen, Vineyard, UT (US); Benjamin Taylor, Provo, UT (US); Joe Fox, Spanish Fork, UT (US); Lloyd J. Wilson, Herriman, UT (US)

(21) Appl. No.: 15/282,009

(22) Filed: Sep. 30, 2016

(51) Int. Cl. B66D 1/38

(52) U.S. Cl. CPC B66D 1/38; B66D 2700/0125

(57) ABSTRACT

A system and method for a winch fairlead pivot are described for reducing friction between a line and the fairlead when letting out or pulling in a line. The winch fairlead pivot includes an upper and a lower pivot that insert into an upper and a lower cavity in the fairlead-frame and upon which the fairlead-frame pivots. The direction of the pivot is dependent upon the direction of a load connected to the line.

### TECHNICAL FIELD

The present disclosure relates generally to the field of motorized winches. More specifically, the present disclosure relates to a winch fairlead-frame.

### BACKGROUND

Winches are hauling or lifting devices, which pull in or let out a line. Winches function by winding or unwinding the line that is coiled around a horizontal rotating drum. A winch fairlead is commonly used to direct the line as it winds or unwinds along the drum. Typically the line must be at a shallow angle to the fairlead in order to minimize friction between the line and the internal edges of the fairlead that surround the line. Thus, a problem arises if the line is connected to a load that is at a wide angle to the fairlead because friction between the line and the fairlead can cause the line to fray. Embodiments and methods disclosed herein may improve winch performance when the load is at a wide angle to the fairlead.

### SUMMARY OF THE INVENTION

Disclosed herein is a winch, comprising a fairlead that pivots toward the direction of a load. In one embodiment, the winch includes a fairlead-frame that includes an upper and a lower cavity, into which an upper and a lower support-pin insert. The upper and lower support-pins allow the fairlead-frame to pivot from side to side, and are attached to a guide. The guide moves along guide-rods connected to a housing for a rotatable drum. As the drum rotates to pull in or let out a line, the guide moves along the guide-rods to evenly distribute the line along the rotatable drum.

Also disclosed herein is a method for reducing friction between a line and a fairlead when pulling in or letting out a line. The method includes rotating the drum and reeling in or letting out the line. The method further includes moving the guide along the length of the drum, and pivoting the fairlead towards the load.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 depicts a winch, according to one embodiment, with a load at a wide angle to the fairlead;

FIG. 2A is a perspective view of an embodiment of a winch, in which a guide includes a fairlead-frame that can pivot within the guide;

FIG. 2B depicts the winch from FIG. 2A with the fairlead-frame pivoted toward the direction of the load;

FIG. 3A illustrates a front view of a fairlead-frame, according to one embodiment;

FIG. 3B is a rear view of the fairlead-frame of FIG. 3B;

FIG. 4 depicts an upper and a lower support-pin of the guide, according to one embodiment;

FIG. 5A is an overhead view of an embodiment of the fairlead-frame within the guide;

FIG. 5B is a cross-sectional view of the fairlead-frame of FIG. 5A;

FIG. 6 is an embodiment of a method for reducing friction between a line and a fairlead when pulling in or letting out a line.

### DETAILED DESCRIPTION

In the following detailed description, numerous specific details are provided for a thorough understanding of the various embodiments disclosed herein. The embodiments disclosed herein can be manufactured without one or more of the specific details, or with other methods, components, materials, etc. In addition, in some cases, well-known structures, or characteristics may be combined in any suitable manner in one or more alternative embodiments.

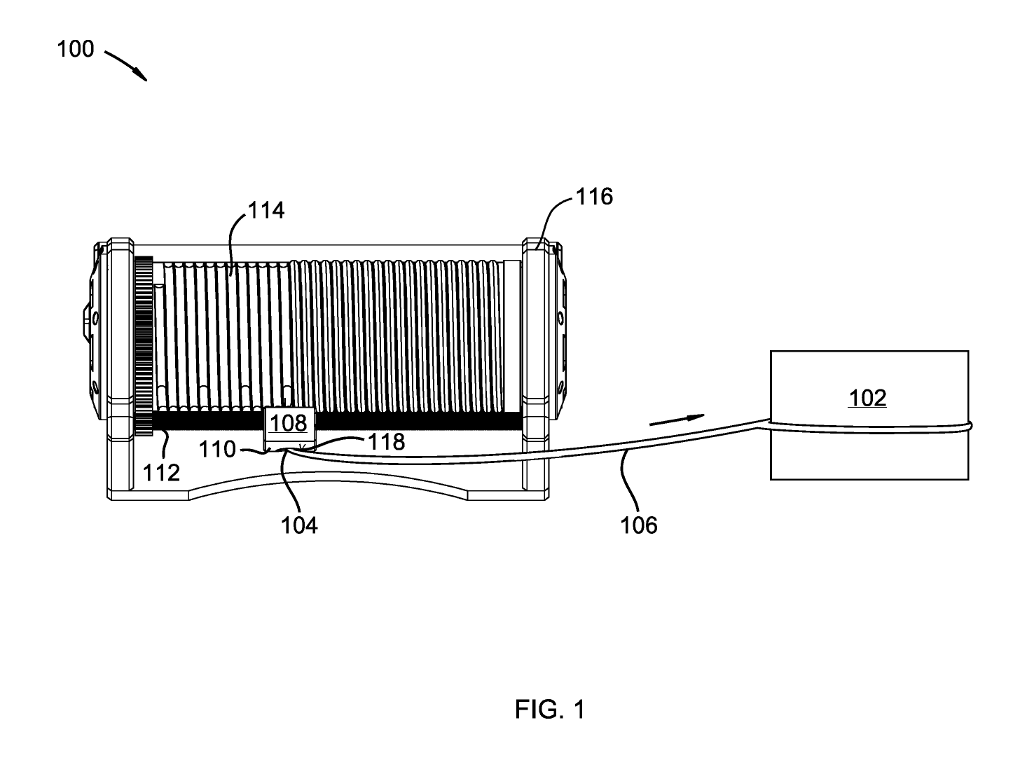

FIG. 1 depicts a winch 100, according to one embodiment, with a load 102 at a wide angle to a fairlead 104. The winch includes a line 106 that connects the load 102 to the winch 100. A guide 108 comprises multiple components including the fairlead 104 and a rotatable fairlead-frame 110 that surrounds the fairlead.

The guide 108 moves along a guide-rod 112, which spans the length of a rotatable drum 114. The rotatable drum 114, for winding and unwinding the line 106, is retained within a housing 116 of the winch 100. The rotatable drum 114 may include a motorized power source, according to one embodiment. Because the load 102 is at a wide angle to the winch 100, the line 106 connecting the load 102 to the winch 100 is at a sharp angle. This sharp angle may cause the line 106 to rub against the fairlead-frame 110 and cause the line 106 to fray 118. The fairlead 104 may include at least one aperture, hole, and/or orifice through which the line 106 penetrates.

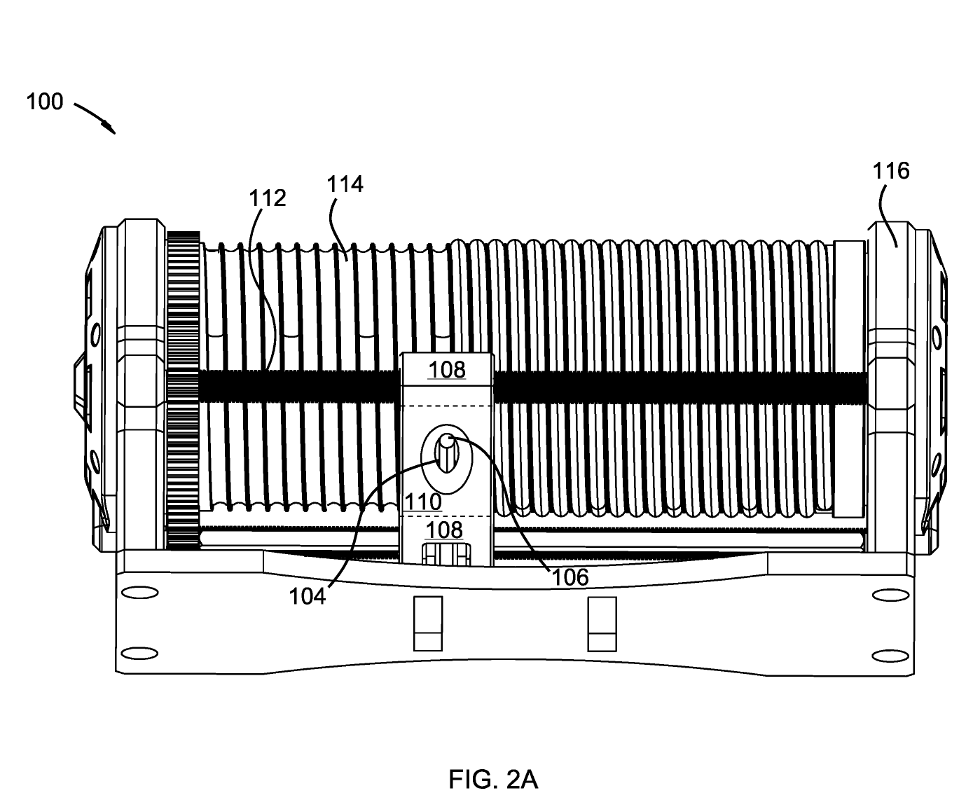

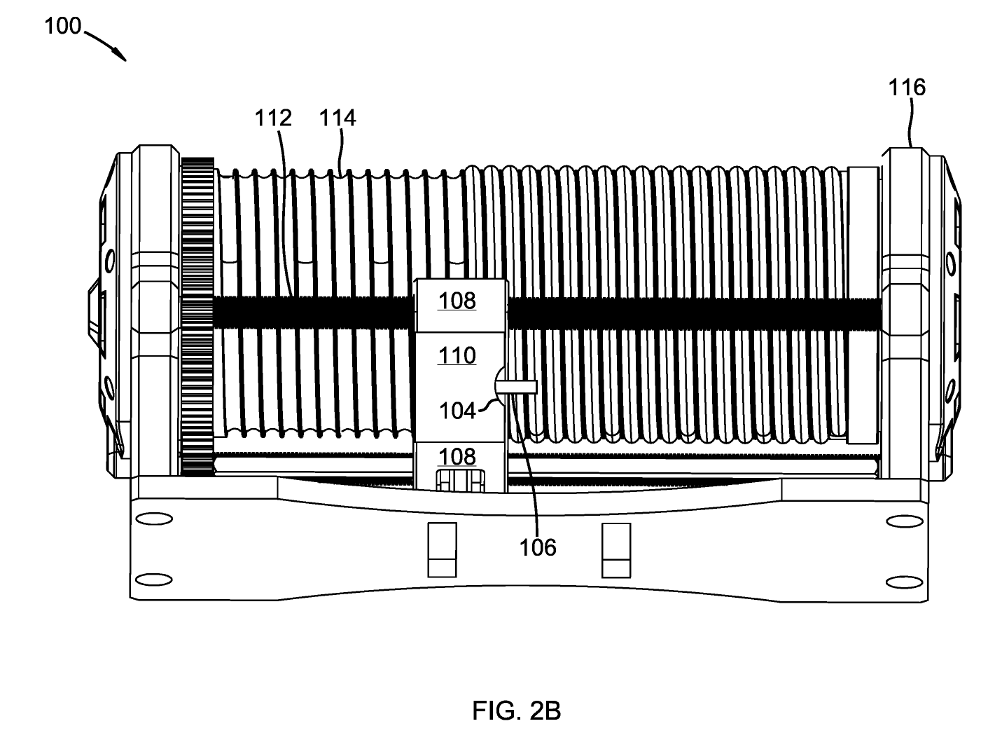

FIG. 2A is a perspective view of an embodiment of a winch 100, in which a guide 108 includes a fairlead-frame 110 that can pivot within the guide 108. The guide 108 moves along a guide-rod 112, which spans the length of the rotatable drum 114. The guide-rod 112 is held in place by a housing 116. Within the fairlead-frame 110 is the fairlead 104 from which the line 106 extends.

In one embodiment, the fairlead-frame 110 extends outward beyond the housing 116. In some embodiments, the housing 116 comprises smooth edges, grooves, and/or rollers such that any contact between the housing 116 and the line 106 has little, if any, friction.

FIG. 2B depicts the winch 100 from FIG. 2A with the fairlead-frame 110 pivoted within the guide toward the direction of the load (not shown).

The guide 108 maintains position and direction on the guide-rod 112, while the fairlead-frame 110 is permitted to move laterally within the framework of the guide 108. Because the fairlead 104 is able to laterally rotate, friction between the line 106 and the fairlead 104 and/or fairlead-frame 110 may be reduced.

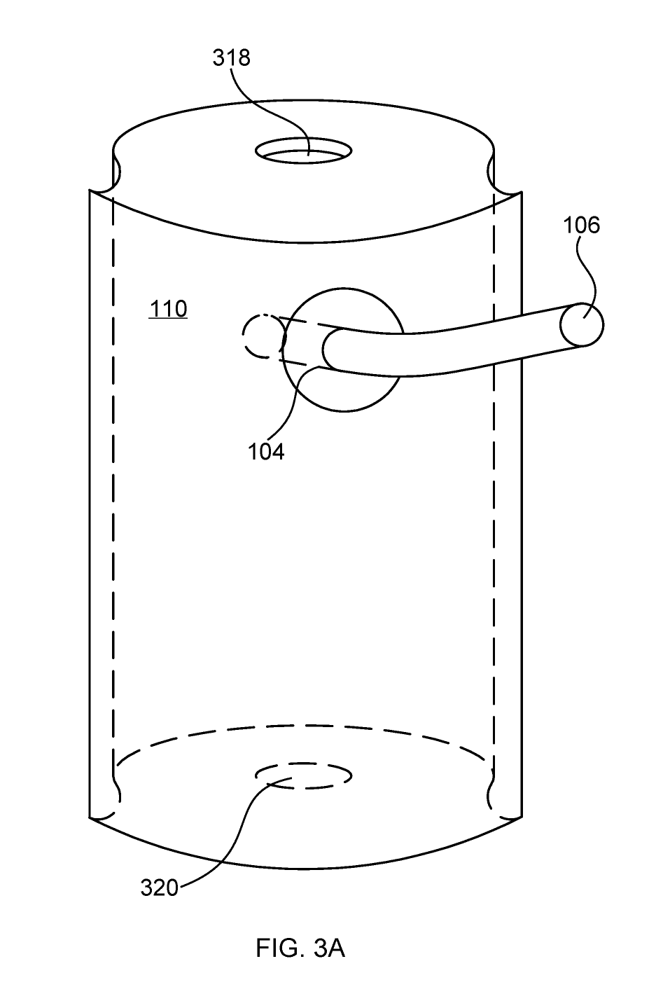

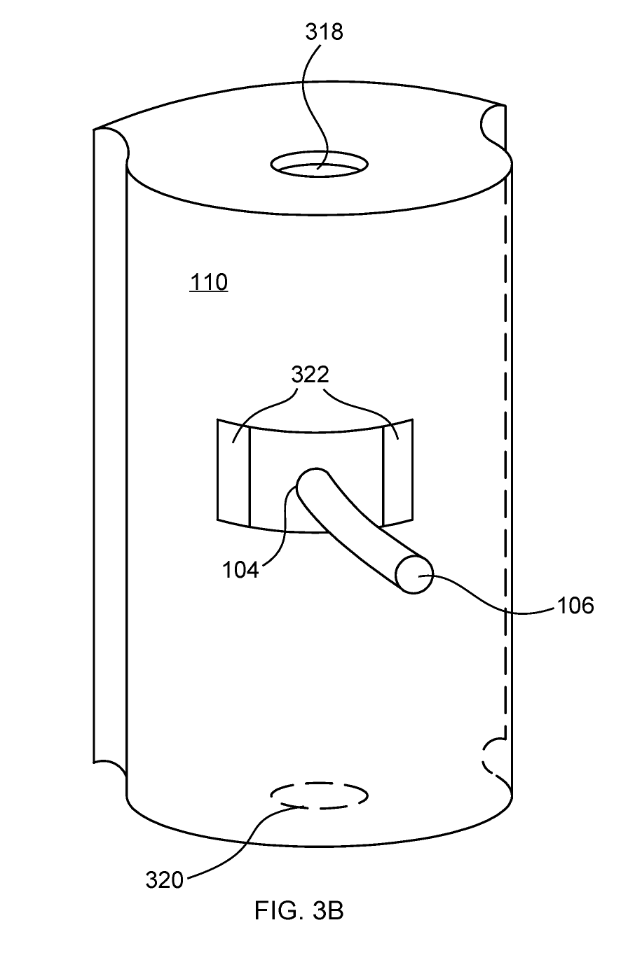

FIG. 3A illustrates a front view of a fairlead-frame 110, according to one embodiment. The fairlead-frame 110 includes an upper 318 and a lower 320 cavity into which the upper and lower support-pins (not shown) insert. The line 106 passes through the fairlead 104 of the fairlead-frame 110.

FIG. 3B is a rear view of the fairlead-frame 110 of FIG. 3B. The fairlead-frame 110 may include rounded edges and/or rollers 322 on the backside of the aperture of the fairlead 104 through which the line 106 passes. The rollers 322 are positioned laterally to the fairlead 104 such that as the fairlead-frame 110 rotates, the line 106 comes into contact with the rollers 322 and smoothly traverses along the rollers 322 as the line 106 is let out and/or pulled in.

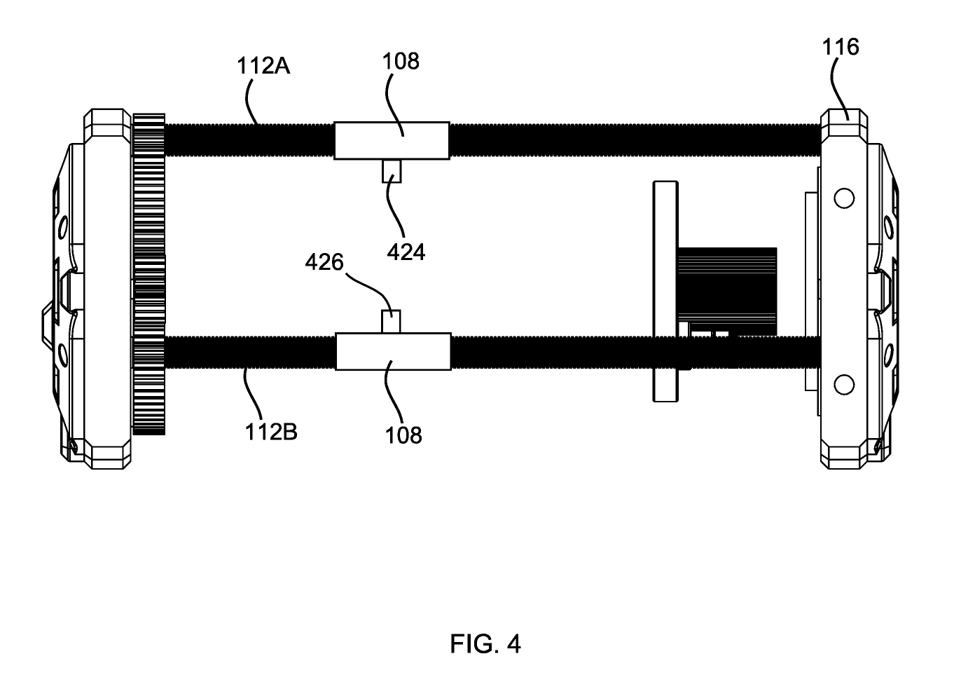

FIG. 4 depicts an upper 424 and a lower 426 support-pin of the guide 108, according to one embodiment, that provide stability to the fairlead-frame (not shown). The upper 424 and lower 426 support-pins are attached to the guide 108, which moves along an upper 112A and a lower 112B guide-rod. The guide-rods 112A, 112B are connected to a housing 116 such that the guide-rods 112A, 112B provide stability to the moving guide 108.

In one embodiment, the upper 424 and lower 426 support-pins may include a lubricant such that rotation of the fairlead-frame (not shown) is further enabled. The upper 424 and lower 426 support-pins may have a smooth surface and/or have a surface with threads, ridges, grooves, channels, ruts, ridges, creases, furrows, and/or any surface inconsistencies, according to one embodiment. The surface inconsistencies may interact with contrasting formations in upper and lower cavities of the fairlead-frame. In one embodiment, the upper 424 and lower 426 support-pins may have a joint that connects the support-pins to the fairlead-frame. The upper 424 and the lower 426 support-pins may be composed of a stronger material than the fairlead-frame, such that the upper 424 and the lower 426 support-pins provide structural stability to the fairlead-frame.

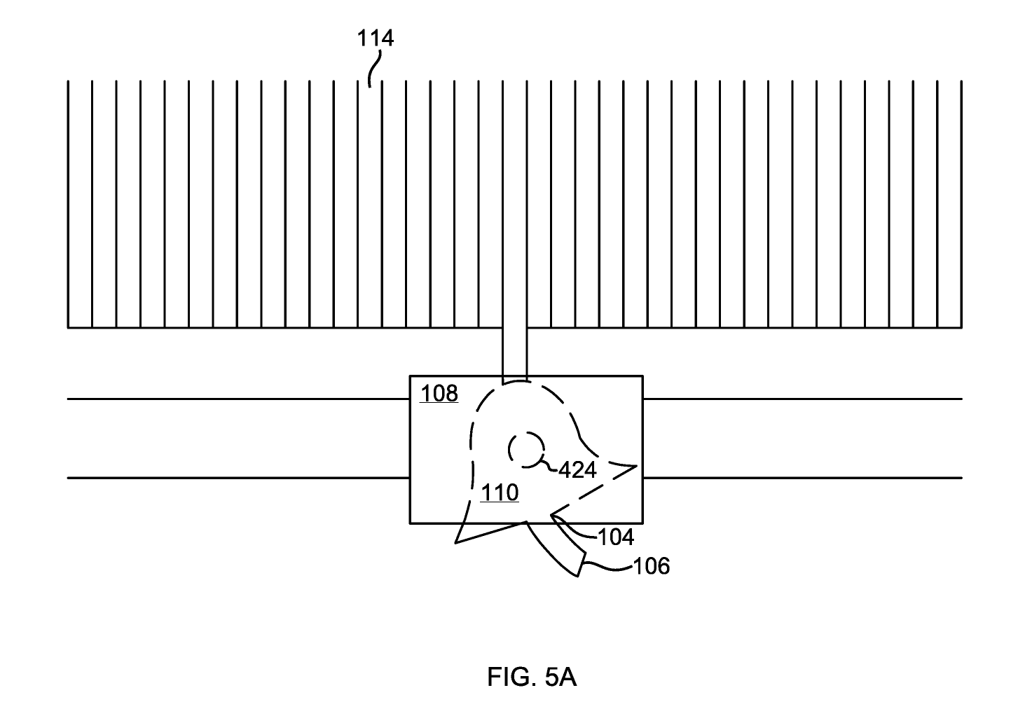

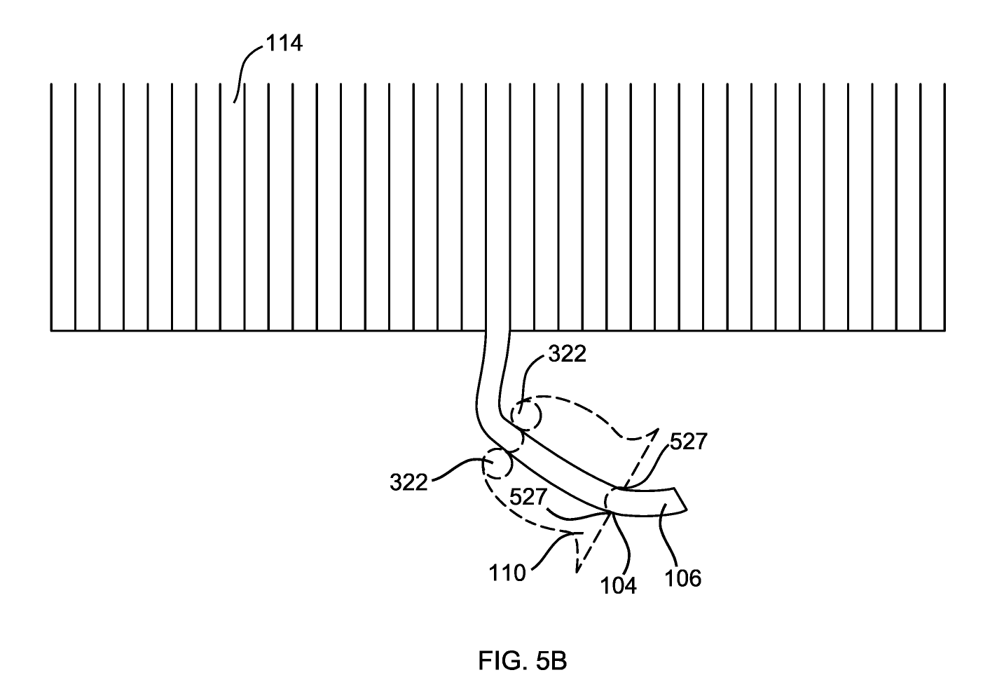

FIG. 5A is an overhead view of an embodiment of the fairlead-frame 110 within the guide 108. The line 106 passes through the fairlead 104 and winds around the rotatable drum 114. The guide-rod 112 provides stability to the guide 108, which includes an upper 424 support-pin that is inserted into the upper 318 cavity of the fairlead-frame 110.

In one embodiment, the guide 108 may include a catch that limits the degree to which the fairlead-frame 110 may rotate. The guide 108, according to one embodiment, may include a hole through which a pin may insert that eliminates the ability of the fairlead-frame 110 to pivot. Other embodiments may include one or more resistive elements in the guide 108 such that the fairlead-frame 110 has few, if any, wobbles when letting in the line 106. Such resistive elements may include bands, elastics, springs, and/or other flexible mechanisms that provide a slight degree of fairlead-frame rotational resistance. The line 106, in some embodiments, may pass through a stopper on the fairlead-frame 110 that acts a buffer to protect the fairlead-frame 110 from forceful impacts of any line-attachments when letting in the line 106.

FIG. 5B is a cross-sectional view of the fairlead-frame 110 of FIG. 5A. The fairlead-frame 110 may include one or more rollers 322 lateral to the line 106. The line 106 passes through the fairlead 104 and winds about the rotatable drum 114. In one embodiment, the fairlead 104 includes rounded, smooth, sharp and/or rough edges 527 on the side opposite the rollers 322 of the fairlead 104 and lateral to the line 106.

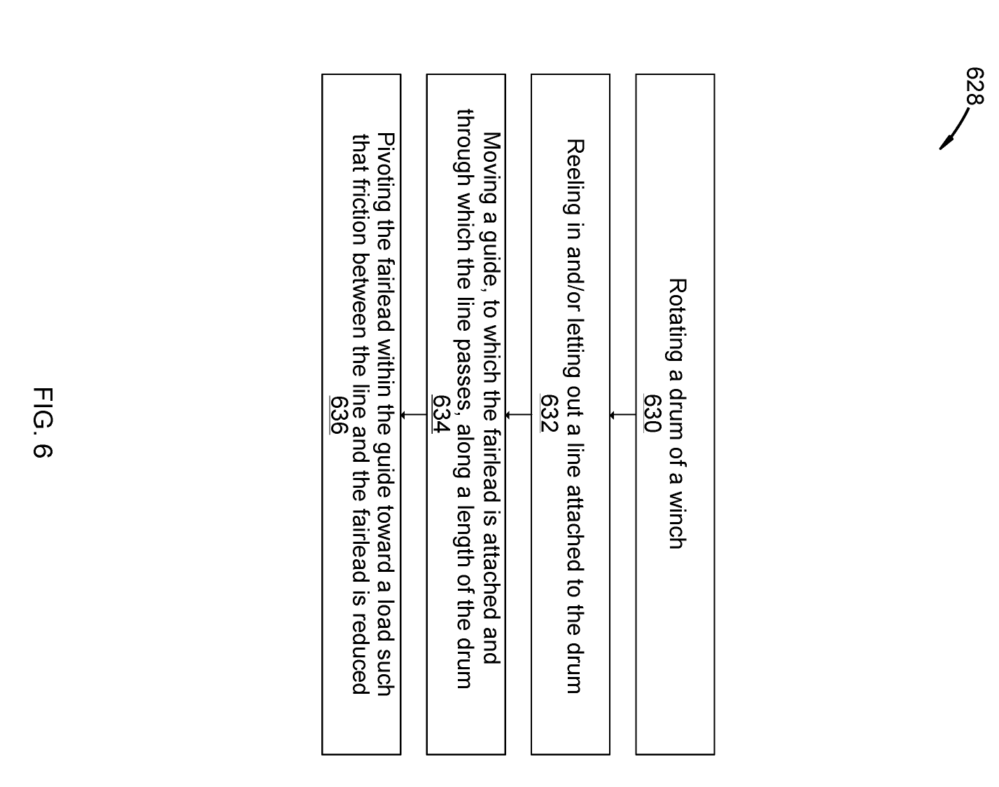

FIG. 6 is an embodiment of a method 628 for reducing friction between a line and a fairlead when pulling in or letting out a line. The method 628 further comprises rotating 630 a drum of a winch, and reeling 632 in and/or letting out a line attached to the drum. The method 628 also includes moving 634 a guide, to which the fairlead is attached and through which the line passes, along a length of the drum. Additionally, the method 628 includes pivoting 636 the fairlead within the guide toward a load such that friction between the line and the fairlead is reduced.

The method 628 may also include resisting rotation of the fairlead to reduce wobbling, according to one embodiment. One embodiment of the method 628 may also include attaching the line to a side load.

1. A winch, comprising:
a rotatable drum for winding and unwinding a line therefrom;
a guide for positioning the line during winding;
wherein the guide moves the line along the rotatable drum length during winding;
wherein guide movement is directed by at least one guide-rod connected to a housing for the rotatable drum;
a fairlead;
wherein the fairlead is surrounded by a rotatable fairlead-frame, with the fairlead and fairlead-frame being components within the guide;
wherein the fairlead-frame pivots within the guide based on load direction; and
an upper and a lower support-pin attached to the guide for supporting the fairlead-frame.

2. The winch of claim 1, wherein the fairlead comprises at least one aperture, hole, and/or orifice through which the line penetrates.

3. The winch of claim 1, wherein the fairlead-frame comprises an upper and a lower cavity into which the upper and lower support-pins insert.

4. The winch of claim 1, wherein the fairlead-frame comprises rounded edges on the side of the fairlead that faces the rotatable drum.

5. The winch of claim 1, wherein the fairlead-frame comprises one or more rollers on the backside of the fairlead directed toward the rotatable drum.

6. The winch of claim 1, wherein the fairlead-frame comprises a stopper that protects the fairlead-frame from forceful impacts of any line attachments when letting in the line.

7. The winch of claim 1, wherein the upper and the lower support-pins comprise a lubricant.

8. The winch of claim 1, wherein the upper and the lower support-pins comprise a smooth surface and/or threads, ridges, grooves, channels, ruts, ridges, creases, furrows, and/or any surface inconsistencies that interact with contrasting formations in upper and lower cavities of the fairlead-frame.

9. The winch of claim 1, wherein the upper and the lower support-pins comprise a joint that connects the support-pins to the fairlead-frame.

10. The winch of claim 1, wherein the upper and the lower support-pins are comprised of a stronger material composition than a force applied to the fairlead-frame, such that the upper and the lower support-pins provide structural stability to the fairlead-frame.

11. The winch of claim 1, wherein the guide comprises a catch to stop rotation of the fairlead-frame.

12. The winch of claim 1, wherein the guide comprises a hole into which a pin is inserted to eliminate the ability of the fairlead-frame to pivot.

13. The winch of claim 1, wherein the guide comprises one or more resistive elements to minimize wobbles of the fairlead-frame when letting in the line.

14. The winch of claim 11, wherein the one or more resistive elements of the guide comprise bands, elastics, springs, and/or other flexible mechanisms that provide a slight degree of fairlead-frame rotational resistance.

15. The winch of claim 1, wherein the fairlead is comprised of sharp and/or rough edges on the outer surface lateral to the line.

16. The winch of claim 1, further comprising a motorized power source.

17. The winch of claim 1, wherein the housing comprises smooth edges, grooves, and/or rollers such that any contact between the housing and the line has little, if any, friction.

18. A method for reducing friction between a line and a fairlead when pulling in or letting out a line comprising:
rotating a drum of a winch;
reeling in and/or letting out a line attached to the drum;
moving a guide, to which the fairlead is attached and through which the line passes, along a length of the drum; and
pivoting the fairlead within the guide toward a load such that friction between the line and the fairlead is reduced.

19. The method of claim 18, further comprising resisting rotation of the fairlead to reduce wobbling.

20. The method of claim 18, further comprising attaching the line to a side load.
